(19) United States
(12) Patent Application Publication
(10) Pub. No.: US 2006/0004656 A1
(43) Pub. Date: Jan. 5, 2006

(54) Electronic money management method and system using mobile communication terminal

(76) Inventor: Jong-Il Lee, Koyang-City (KR)

Correspondence Address: CANTOR COLBURN, LLP, 55 GRIFFIN ROAD SOUTH, BLOOMFIELD, CT, 06002, US

(21) Appl. No.: 11/179,769

(22) Filed: Jul. 12, 2005

Related U.S. Application Data
(63) Continuation-in-part of application No. 09/796,827, filed on Mar. 2, 2001.

(30) Foreign Application Priority Data
Dec. 28, 1999 (KR) 1999-63144

(51) Int. Cl. G06F 17/60

(52) U.S. Cl. 705/39

(57) ABSTRACT

An electronic money management method and system using a mobile phone is provided, which can be applied to electronic transactions. Upon receiving a request regarding electric money such as issuance, recharging, transfer, or balance checking, together with a mobile phone number and a password, from a user, an ARS server, an electronic money management web server, or an mobile communication service system transmits an authentication number to the user's mobile phone, compares the transmitted authentication number with one received from the user, and transmits the password and phone number to make the request if the authentication numbers are identical. The electronic money management server fulfills the request regarding electronic money, received from the one server or system, for an electronic money account identified by the password and mobile phone number, and transmits the fulfilled result and the account balance to the mobile phone through the one server or system.

### RELATED APPLICATIONS

This application claims priority from and is a continuation-in-part (CIP) of U.S. patent application Ser. No. 09/796,827, filed Mar. 2, 2001, and entitled “METHOD AND SYSTEM FOR TRANSACTION OF ELECTRONIC MONEY WITH A MOBILE COMMUNICATION UNIT AS AN ELECTRONIC WALLET”, the disclosure which is incorporated herein by reference.

### BACKGROUND OF THE INVENTION

1. Field of the Invention

The present invention relates to an electronic money management method and system that can be applied to electronic transactions.

2. Description of the Related Art

Conventionally, credit cards, debit cards, or bank account transfers have been used to pay prices for general commercial transactions or electronic transactions. However, the conventional payment methods have many inconveniences and technical problems in application to electronic transactions. For example, teenagers or other people, to whom credit cards are not allowed to be issued since they have no income or due to other reasons, cannot conduct electronic transactions.

In addition, the use of credit cards is avoided in low-cost electronic transactions such as music file downloading for safety reasons. In an approach introduced to solve these problems, users individually purchase cards on which encrypted numbers are written due to concerns about disclosure of credit card information.

In the payment method through bank account transfer, it takes one or more days to confirm transfer so that users cannot immediately use the service. It is also inconvenient for users to visit banks or use telebanking or PC banking to perform bank account transfer.

A new electronic money management system has been proposed in an attempt to overcome these problems. Such technologies regarding electronic monetary are described in U.S. Pat. Nos. 5,963,648, 5,920,629, and 5,953,423.

The electronic money management technologies disclosed in the above United States patents can be mainly classified into card-based and encrypted number-based types. The card-based system employs magnetic or IC cards so that it is inconvenient for card member stores to be equipped with card readers. In the card-based electronic money management system, it is also convenient for users to use dedicated terminals to check the balances of their cards. The card-based system also has no effective security solution to prevent the cards from being stolen or copied and then used by others.

The electronic money management system based on encrypted numbers is advantageous over the card-based system in that it is possible to instantly issue encrypted numbers of 12 to 16 digits. However, the encrypted number-based system requires users to memorize and secure their encrypted numbers. The encrypted number-based system also requires connection to a central computer in order to check the balance and cannot verify the identities of users when their encrypted numbers are copied or stolen.

Thus, there is a need to provide a new electronic money management system which overcomes the problems of the magnetic or IC card and encrypted number-based systems and which allows users to securely conduct low-cost electronic transactions regardless of time or place.

### SUMMARY OF THE INVENTION

Therefore, the present invention has been made in view of the above problems, and it is an object of the present invention to provide an electronic money management method and system which allows users to conveniently and securely conduct issuance, recharging, transfer, use, and balance checking of electronic money under electronic transaction environments.

In accordance with one aspect of the present invention, the above and other objects can be accomplished by the provision of an electronic money management system comprising one of an ARS server, an electronic money management web server, and a mobile communication service system which transmits an authentication number to a mobile communication terminal of a user upon receiving an electric money issuance, recharging, transfer, or balance checking request, together with a mobile communication terminal number of the user and a password for use in electronic money transactions, from the user, compares the authentication number transmitted to the mobile communication terminal of the user with an authentication number received from the user, and transmits the password and the mobile communication terminal number of the user to make the electric money issuance, recharging, transfer, or balance checking request if the two authentication numbers are identical; and an electronic money management server for issuing electronic money to, recharging electronic money to, or transferring electronic money from an electronic money account identified by the password and the mobile communication terminal number of the user upon receiving the electric money issuance, recharging, transfer, or balance checking request from the one of the ARS server, the electronic money management web server, and the mobile communication service system, and for transmitting a result of the electronic money issuance, recharging, or transfer and a balance of the electronic money account of the user to the mobile communication terminal of the user through the one of the ARS server, the electronic money management web server, and the mobile communication service system.

In accordance with another aspect of the present invention, there is provided a method for managing electronic money for use in electronic transactions, the method comprising an Automatic Response System (ARS) server receiving electronic money issuance data from a user telephone, the electronic money issuance data including a mobile communication terminal number of a user, a password for use in electronic money transactions, and an amount of electronic money which the user desires to be issued; the ARS server transmitting an authentication number to a mobile communication terminal of the user; the ARS server receiving an authentication number input by the user from the user telephone; the ARS server comparing the authentication number input by the user with the authentication number transmitted to the mobile communication terminal of the user and transmitting the electronic money issuance data to an electronic money management server to request that the electronic money management server issue the amount of electronic money if the authentication numbers are identical; the electronic money management server issuing the requested amount of electronic money to an electronic money account of the user identified by the password and the mobile communication terminal number of the user; and the ARS server notifying the mobile communication terminal of the user of completion of the electronic money issuance if the electronic money has been issued.

Preferably, upon receiving the request to issue electronic money, the electronic money management server searches for the electronic money account of the user identified by the password and the mobile communication terminal number of the user, opens a new electronic money account identified by the password and the mobile communication terminal number of the user if the electronic money account of the user is not present, and recharges the electronic money account of the user with the requested amount of electronic money if the electronic money account of the user is present.

Preferably, if the electronic money issuance is completed, the ARS server transmits a Short Message Service (SMS) message to the mobile communication terminal, the SMS message containing at least one of a balance of the electronic money account, an issued amount of money, and a recharged amount of money, or containing a combination thereof.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram illustrating the configuration of an electronic money management system according to a preferred embodiment of the present invention;

FIGS. 2a to 2e are flow diagrams of a method for newly issuing electronic money according to preferred embodiments of the present invention;

FIGS. 3a to 3e are flow diagrams of a method for recharging (or depositing) electronic money according to preferred embodiments of the present invention;

FIGS. 4a and 4b are flow diagrams of a method for transferring electronic money according to preferred embodiments of the present invention;

FIGS. 5a and 5b are flow diagrams of a method for conducting electronic transactions using electronic money according to preferred embodiments of the present invention; and

FIGS. 6a to 6c are flow diagrams of a method for checking the balance of an electronic money account according to preferred embodiments of the present invention.

### DESCRIPTION OF THE PREFERRED EMBODIMENTS

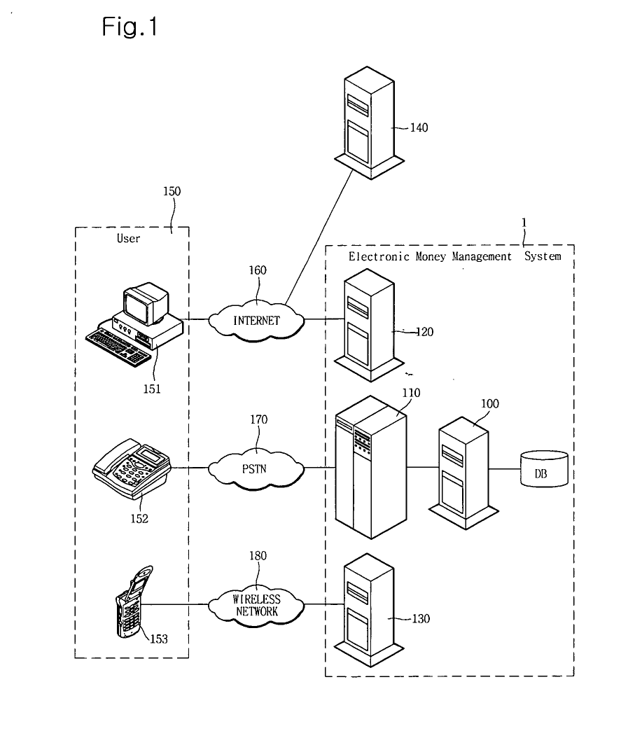

Preferred embodiments of the present invention will now be described in detail with reference to FIGS. 1 to 6.

FIG. 1 is a schematic diagram illustrating the configuration of an electronic money management system according to a preferred embodiment of the present invention. As shown in FIG. 1, the electronic money management system 1 according to the present invention includes an electronic money management server 100, an Automatic Response System (ARS) server 110, an electronic money management web server 120, and a mobile communication service system (for example, a WAP server) 130.

A user 150 uses a computer 151, a telephone 152, or a mobile communication terminal (for example, a mobile phone) 153 to access the electronic money management server 100 through the Internet 160, a PSTN 170, or a wireless network 180 so that the user can conduct electronic money transactions such as electronic money issuance, recharging, transfer, and balance checking.

A mobile communication terminal 153 of the user is capable of performing security/authentication functions for electronic money transactions such as electronic money issuance, recharging, transfer, and balance checking.

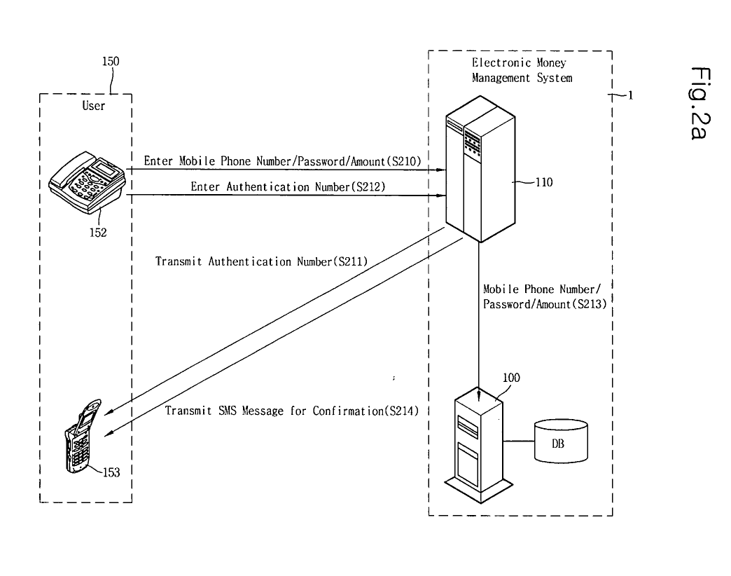

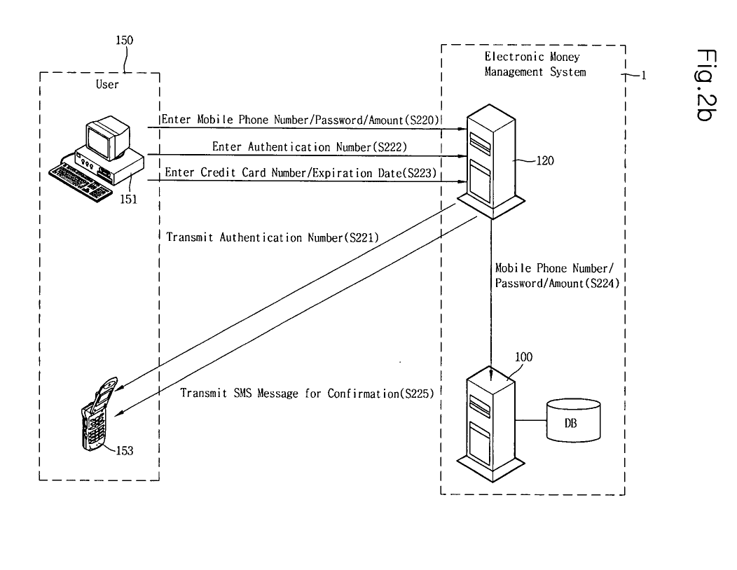

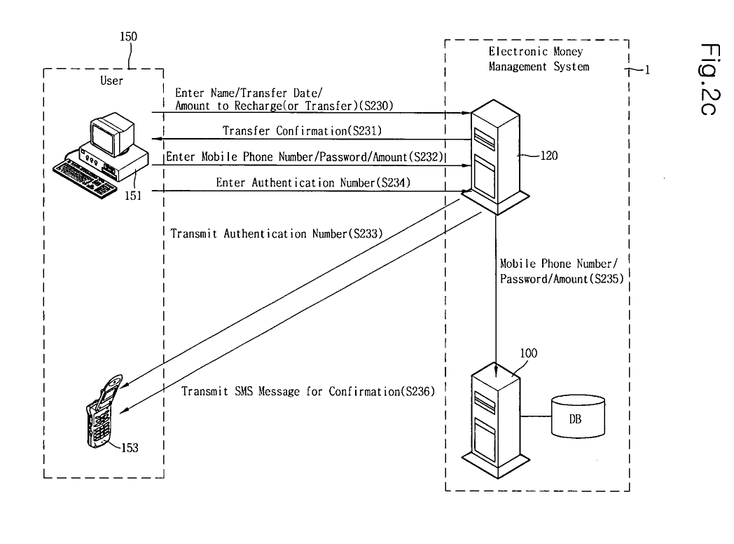

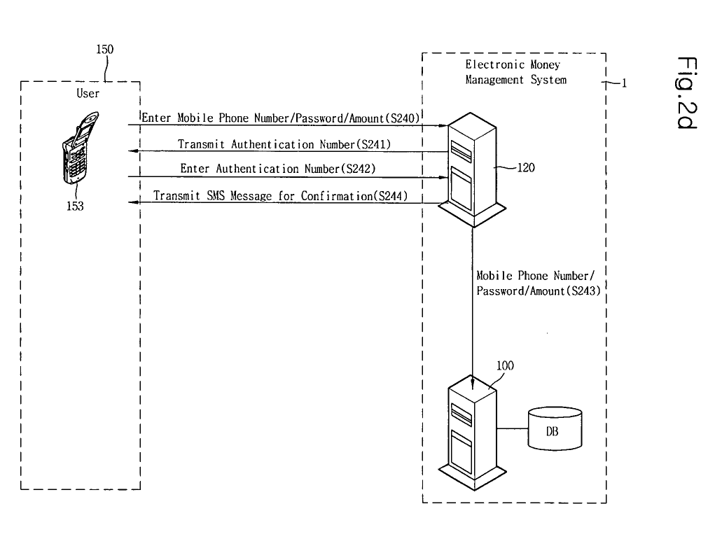

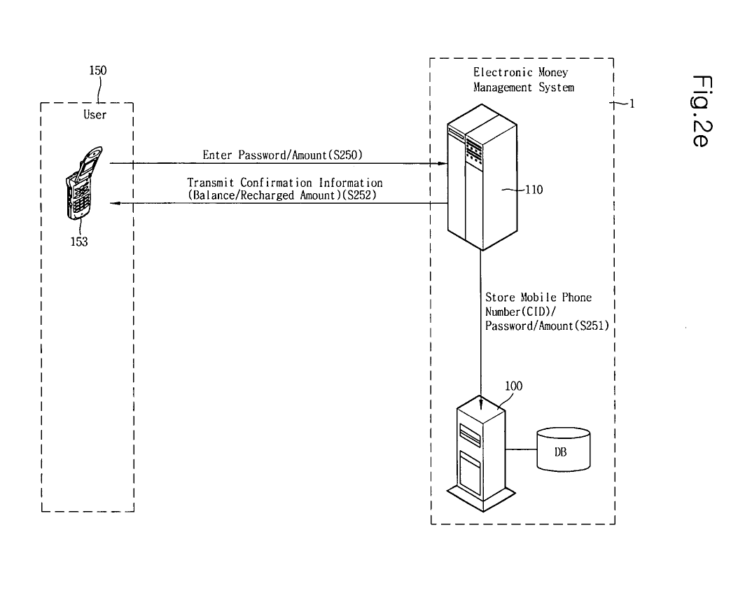

FIG. 2a is a flow diagram illustrating the procedure of a method for issuing electronic money according to a first embodiment of the present invention. As shown in FIG. 2a, for issuance of electronic money, a user 150 accesses an ARS server 110 through a telephone 152 and inputs their mobile communication terminal number, their password for use in electronic money transactions, and the amount of electronic money the user desires to be issued (S210).

More preferably, a social security number of the owner of the mobile communication terminal is input together with the mobile communication terminal number in order to determine whether or not the holder of the mobile communication terminal is the genuine owner subscribed to the mobile communication service, through inquiry to the mobile communication company.

In the present invention, a mobile phone is preferably used as the mobile communication terminal 153. Since owners of mobile communication terminals (or mobile phones) typically carry them at all times, it is possible to verify the identity of the user 150 by verifying the identity of the holder of the mobile communication terminal.

When data required for electronic money issuance is input through the user telephone 152 as described above, the ARS server 110 transmits a randomly generated authentication number to the mobile communication terminal 153 of the user (S211). The user 150 can successfully receive the authentication number if the user 150 is currently in possession of their mobile communication terminal 153.

The user 150 inputs the authentication number, received through their mobile communication terminal 153, to the ARS server 110 through the telephone 152 (S212). If the authentication number input by the user 150 is identical to the authentication number transmitted to the mobile communication terminal 153, the ARS server 110 regards the identity of the user as having been verified.

If the identity of the user is verified in this manner, the ARS server 110 transmits data, such as the mobile communication terminal number, the password, and the amount of electronic money requested to be issued, to the electronic money management server 100 to request that the electronic money management server 100 open a new electronic money account and issue electronic money (S213).

The mobile communication terminal number, the password, and the social security number stored in the electronic money management server 100 are used to authenticate the user 150 when the user 150 uses electronic money.

If the electronic money management server 100 completes opening of the electronic money account and issuance of the requested amount of electronic money, the ARS server 110 transmits a Short Message Service (SMS) message, which indicates that the requested amount of electronic money has been successfully issued to the electronic money account of the user, to the mobile communication terminal 153 of the user (S214). The SMS message may include a balance of the electronic money account, the amount of electronic money issued, and the like.

The electronic money issuance method according to the first embodiment of the present invention opens an electronic money account identified by the mobile communication terminal number and the password of the user and issues the amount of electronic money, requested by the user, to the opened electronic money account. This method achieves secure transaction by verifying the identity of the user and their intention to conduct transactions through the mobile communication terminal held by the user.

In the first embodiment of the present invention, a fee for electronic money issuance is charged by adding it to an information access fee in a bill of the ARS line provider company.

FIG. 2b is a flow diagram illustrating the procedure of a method for issuing electronic money according to a second embodiment of the present invention. As shown in FIG. 2b, a user 150 can be issued electronic money by accessing an electronic money management web server 120 through a user computer 151.

Specifically, the user 150 accesses the electronic money management web server 120 through the user computer 151 and inputs their mobile communication terminal number, their password for use in electronic money transactions, and the amount of electronic money the user desires to be issued (S220).

More preferably, a social security number of the owner of the mobile communication terminal is input together with the mobile communication terminal number in order to determine whether or not the holder of the mobile communication terminal is the genuine owner subscribed to the mobile communication service, through inquiry to the mobile communication company.

When data required for electronic money issuance is input through the user computer 151 as described above, the electronic money management web server 120 transmits a randomly generated authentication number to the input mobile communication terminal number of the user (S221).

The user 150 can successfully receive the authentication number if the user 150 is currently in possession of their mobile communication terminal 153. The user inputs the received authentication number to the electronic money management web server 120 through the user computer 151 (S222). If the authentication number input through the user computer 151 is identical to the authentication number transmitted to the mobile communication terminal 153, the electronic money management web server 120 regards the identity of the user as having been verified, and terminates the authentication process and proceeds to a payment process.

The user can select a credit or debit card as means for paying a fee for the electronic money issuance. If the user selects a credit card, the user can pay the electronic money issuance fee by inputting a credit card number, an expiration date, and the like (S223).

If the payment process is completed, the electronic money management web server 120 transmits data such as the mobile communication terminal number, the password, and the paid amount of money to the electronic money management server 100 to request that the electronic money management server 100 open a new electronic money account and issue electronic money (S224). The mobile communication terminal number, the password, and the social security number stored in the electronic money management server 100 are used to authenticate the user 150 when the user 150 uses electronic money.

If the electronic money management server 100 completes opening of the electronic money account and issuance of the requested amount of electronic money, the electronic money management web server 120 transmits an SMS message, which indicates that the requested amount of electronic money has been successfully issued to the electronic money account of the user, to the mobile communication terminal 153 of the user (S225). The SMS message may include a balance of the electronic money account, the amount of electronic money issued, and the like.

FIG. 2c is a flow diagram illustrating the procedure of a method for issuing electronic money according to a third embodiment of the present invention. As shown in FIG. 2c, a user 150 can open an electronic money account via bank account transfer.

Specifically, the user 150 transfers an amount of money, which corresponds to an amount of electronic money the user desires to be issued, to a bank account of the electronic money management company. The user 150 then accesses an electronic money management web server 120 through a user computer 151 and inputs account transfer information, such as the user name, transfer date, and transfer amount (i.e., remittance), to the electronic money management web server 120 (S230).

The electronic money management web server 120 confirms the transfer of money from the user using the input account transfer information, and proceeds to an electronic money account opening process if the transfer of money from the user is confirmed.

Specifically, if the transfer of money from the user is confirmed, the electronic money management web server 120 notifies the user 150 of the confirmation (S231). Then, through the user computer 151, the user 150 inputs their mobile communication terminal number, their password for use in electronic money transactions, and the amount of electronic money the user desires to be issued (S232).

More preferably, a social security number of the owner of the mobile communication terminal is input together with the mobile communication terminal number in order to determine whether or not the holder of the mobile communication terminal is the genuine owner subscribed to the mobile communication service, through inquiry to the mobile communication company.

When data required for electronic money issuance is input through the user computer 151 as described above, the electronic money management web server 120 transmits a randomly generated authentication number to the mobile communication terminal number of the user (S233).

The user 150 can successfully receive the authentication number if the user 150 is currently in possession of their mobile communication terminal 153. The user inputs the received authentication number to the electronic money management web server 120 through the user computer 151 (S234). If the authentication number input by the user is identical to the authentication number transmitted to the mobile communication terminal 153, the electronic money management web server 120 regards the identity of the user as having been verified.

If the identity of the user is verified in this manner, the electronic money management web server 120 transmits data such as the mobile communication terminal number, the password, and the transferred amount of money (i.e., remittance) to the electronic money management server 100 to request that the electronic money management server 100 open a new electronic money account and issue electronic money (S235).

The mobile communication terminal number, the password, and the social security number stored in the electronic money management server 100 are used to authenticate the user 150 when the user 150 uses electronic money.

If the electronic money management server 100 completes opening of the electronic money account and issuance of the requested amount of electronic money, the electronic money management web server 120 transmits an SMS message, which indicates that the requested amount of electronic money has been successfully issued, to the mobile communication terminal 153 of the user (S236). The SMS message may include a balance of the electronic money account, the amount of electronic money issued, and the like.

FIG. 2d is a flow diagram illustrating the procedure of a method for issuing electronic money according to a fourth embodiment of the present invention. The first embodiment of the present invention charges a fee for electronic money issuance by adding it to an information access fee in a bill of the ARS line provider company, whereas the fourth embodiment discloses a method for charging a fee for electronic money issuance by adding it to an information access fee in a bill of a mobile communication company.

As shown in FIG. 2d, for issuance of electronic money, a user 150 accesses a mobile communication service system 130 through their mobile communication terminal 153 and inputs their mobile communication terminal number, their password for use in electronic money transactions, and the amount of electronic money the user desires to be issued (S240).

More preferably, a social security number of the owner of the mobile communication terminal is input together with the mobile communication terminal number in order to determine whether or not the holder of the mobile communication terminal is the genuine owner subscribed to the mobile communication service, through inquiry to the mobile communication company.

When data required for electronic money issuance is received from the mobile communication terminal 153 as described above, the mobile communication service system 130 transmits a randomly generated authentication number to the input mobile communication terminal number of the user (S241).

The user 150 can successfully receive the authentication number if the user 150 is currently in possession of their mobile communication terminal 153. The user inputs the received authentication number to the mobile communication service system 130 through the mobile communication terminal 153 (S242). If the authentication number input by the user is identical to the authentication number transmitted to the mobile communication terminal 153, the mobile communication service system 130 regards the identity of the user as having been verified and then completes the authentication process.

If the identity of the user is verified in this manner, the mobile communication service system 130 transmits data, such as the mobile communication terminal number, the password, and the amount of electronic money requested to be issued, to the electronic money management server 100 to request that the electronic money management server 100 open a new electronic money account and issue electronic money (S243).

The mobile communication terminal number, the password, and the social security number stored in the electronic money management server 100 are used to authenticate the user 150 when the user 150 uses electronic money.

If the electronic money management server 100 completes opening of the electronic money account and issuance of the requested amount of electronic money, the mobile communication service system 130 transmits an SMS message, which indicates that the requested amount of electronic money has been successfully issued, to the mobile communication terminal 153 of the user (S244). The SMS message may include a balance of the electronic money account, the amount of electronic money issued, and the like.

FIG. 2e is a flow diagram illustrating the procedure of a method for issuing electronic money according to a fifth embodiment of the present invention. As shown in FIG. 2e, for issuance of electronic money, a user 150 accesses an ARS server 110 through their mobile communication terminal 153 and inputs a password for use in electronic money transactions and the amount of electronic money the user desires to be issued (S250). In this embodiment, input of the mobile communication terminal number of the user can be omitted since the ARS server 110 can detect a Caller Identification (CID) of the mobile communication terminal 153, contrary to the first embodiment of the present invention.

More preferably, a social security number of the owner of the mobile communication terminal is input together with the mobile communication terminal number in order to determine whether or not the holder of the mobile communication terminal is the genuine owner subscribed to the mobile communication service, through inquiry to the mobile communication company.

In this embodiment, the authentication number verification process performed in the first embodiment can be omitted since the user 150 has already been determined to be the holder of the mobile communication terminal 153.

Accordingly, in the fifth embodiment, the ARS server 110 transmits data, such as the CID (i.e., the mobile communication terminal number of the user), the password, and the amount of electronic money requested to be issued, to the electronic money management server 100 to request that the electronic money management server 100 open a new electronic money account and issue electronic money (S251).

If the electronic money management server 100 completes opening of the electronic money account and issuance of the requested amount of electronic money, the ARS server 110 transmits a Short Message Service (SMS) message, which indicates that the requested amount of electronic money has been successfully issued, to the mobile communication terminal 153 of the user (S252). The SMS message may include a balance of the electronic money account, the amount of electronic money issued, and the like.

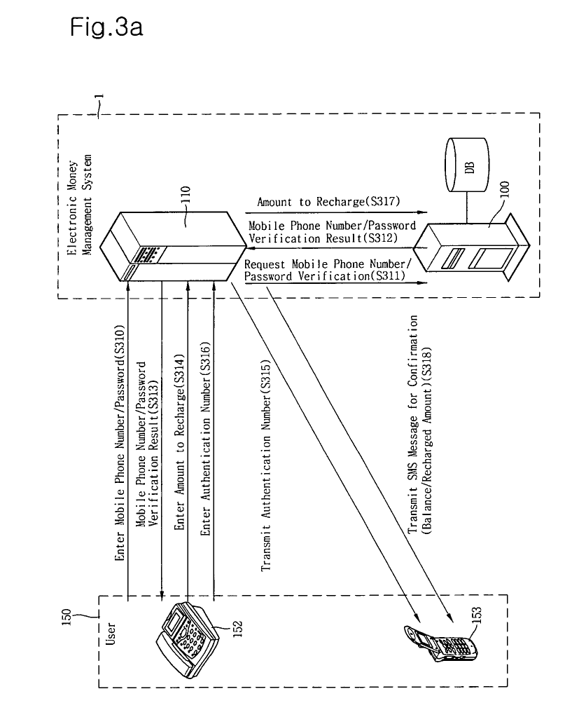

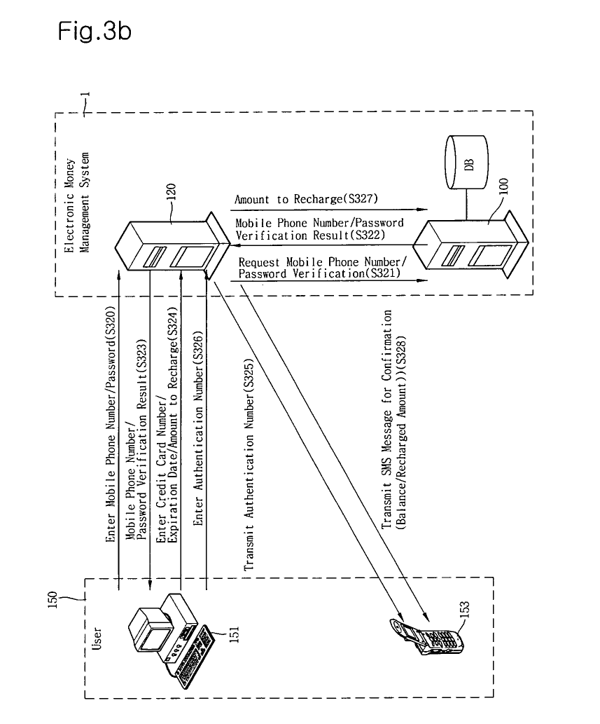

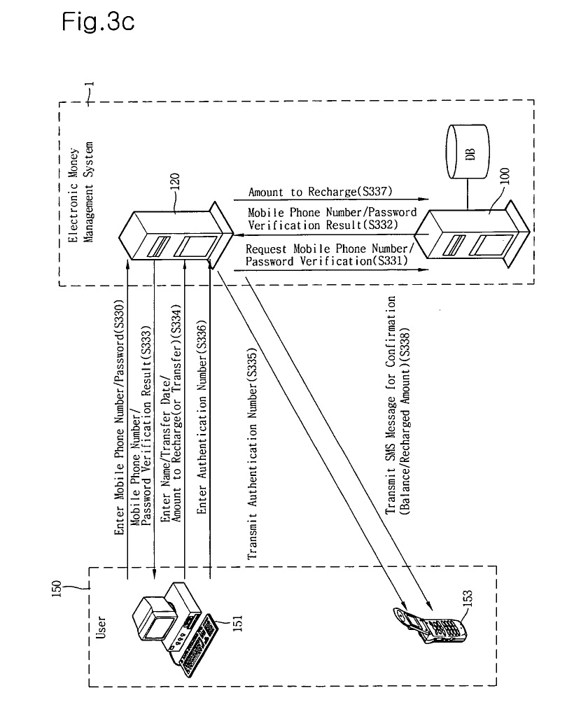

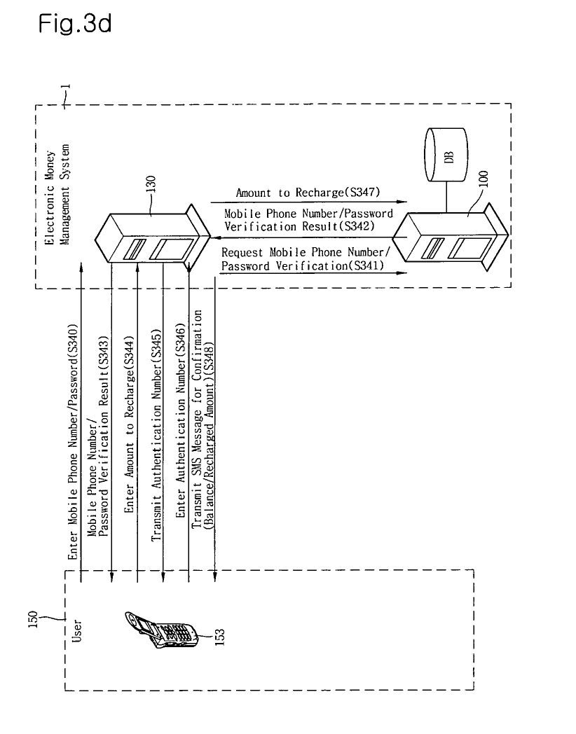

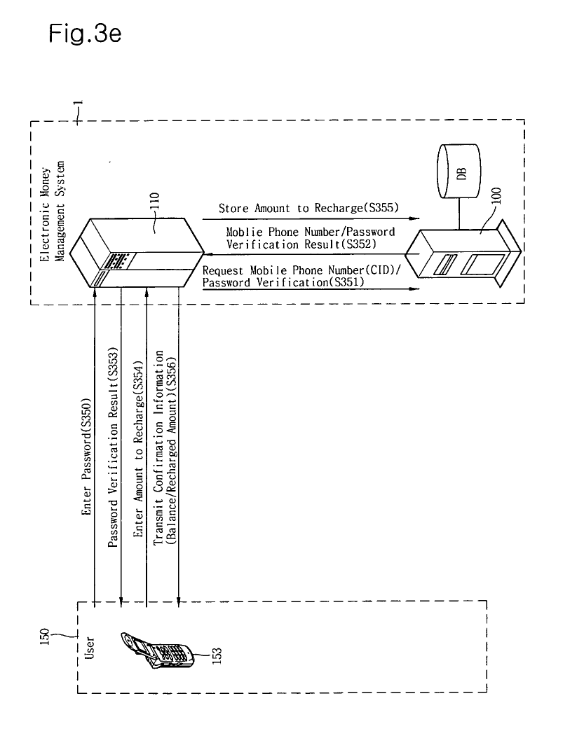

While the above embodiments have described the procedure for issuing new electronic money, it is also possible to recharge an already opened account with electronic money according to the methods described below with reference to FIGS. 3a to 3d.

FIG. 3a is a flow diagram illustrating the procedure of a method for recharging electronic money according to a sixth embodiment of the present invention. The procedure of the electronic money recharging method according to the sixth embodiment of the present invention is similar to that of the electronic money issuance method according to the first embodiment of the present invention shown in FIG. 2a. However, in the sixth embodiment, a mobile communication terminal number and a password for use in electronic money transactions are input only to achieve user authentication since an electronic money account of the user has already been opened.

Specifically, if a user 150 accesses an ARS server 110 through their telephone 152 and inputs their mobile communication terminal number and their password (S310), the ARS server 110 transmits the input information to an electronic money management server 100 to request that the electronic money management server 100 confirm whether or not the input mobile communication terminal number and password is identical to a mobile communication terminal number and password stored in the electronic money management server 100 when an electronic money account of the user was opened (S311).

More preferably, a social security number of the owner of the mobile communication terminal is input together with the mobile communication terminal number in order to strengthen the security of the user authentication process.

If the data input by the user is identical to data stored in the electronic money management server 100 (S312), the ARS server 110 notifies the user accordingly (S313). Thereafter, the user inputs an amount of electronic money, which the user wishes to recharge, through the user telephone 152 (S314), and the ARS server 110 transmits a randomly generated authentication number to the mobile communication terminal number of the user (S315).

If the user inputs the received authentication number to the ARS server 110 through the user telephone 152 (S316), the ARS server 110 compares the authentication number input by the user with the authentication number transmitted to the mobile communication terminal 153. If the two authentication numbers are identical, the ARS server 110 completes the user authentication and requests that the electronic money management server 100 recharge the electronic money account of the user with the amount of electronic money input by the user (S317).

In addition, the ARS server 110 transmits an SMS message, which indicates that the requested amount of electronic money has been successfully recharged to the electronic money account of the user, to the mobile communication terminal 153 of the user (S318). The SMS message may include a balance of the electronic money account, the recharged amount of electronic money, and the like.

In the sixth embodiment of the present invention, a fee for electronic money recharging is charged by adding it to an information access fee in a bill of the ARS line provider company.

FIG. 3b is a flow diagram illustrating the procedure of a method for recharging electronic money according to a seventh embodiment of the present invention. The electronic money recharging method according to the seventh embodiment of the present invention pays a fee for electronic money recharging via a credit or debit card in a similar manner to the electronic money issuance method according to the second embodiment.

Specifically, if the user 150 accesses the electronic money management web server 120 through their computer 151 and inputs their mobile communication terminal number and their password for use in electronic money transactions (S320), the electronic money management web server 120 transmits the input information to an electronic money management server 100 to request that the electronic money management server 100 confirm whether or not the input mobile communication terminal number and password is identical to a mobile communication terminal number and password stored in the electronic money management server 100 when an electronic money account of the user was opened (S321).

More preferably, a social security number of the owner of the mobile communication terminal is input together with the mobile communication terminal number in order to strengthen the security of the user authentication process.

If the data input by the user is identical to data stored in the electronic money management server 100 (S322), the electronic money management web server 120 notifies the user accordingly (S323). Then, the user can select a credit or debit card as means for paying a fee for the electronic money recharging. If the user selects a credit card, the user can pay the electronic money recharging fee by inputting a credit card number, an expiration date, and the like (S324).

If the payment process is completed, the electronic money management web server 120 transmits a randomly generated authentication number to the mobile communication terminal number of the user (S325). If the user inputs the received authentication number to the electronic money management web server 120 through the user computer 151 (S326), the electronic money management web server 120 compares the authentication number input by the user with the authentication number transmitted to the mobile communication terminal 153. If the two authentication numbers are identical, the electronic money management web server 120 completes the user authentication and requests that the electronic money management server 100 recharge the electronic money account of the user with the amount of electronic money input by the user (S327).

In addition, the electronic money management web server 120 transmits an SMS message, which indicates that the requested amount of electronic money has been successfully recharged to the electronic money account of the user, to the mobile communication terminal 153 of the user (S328). The SMS message may include a balance of the electronic money account, the recharged amount of electronic money, and the like.

FIG. 3c is a flow diagram illustrating the procedure of a method for recharging electronic money according to an eighth embodiment of the present invention. The electronic money recharging method according to the eighth embodiment of the present invention pays a fee for electronic money recharging via bank account transfer in a similar manner to the electronic money issuance method according to the third embodiment.

Specifically, if the user 150 transfers an amount of money, which corresponds to an amount of electronic money the user desires to recharge, to a bank account of the electronic money management company, and then accesses the electronic money management web server 120 through their computer 151 and inputs their mobile communication terminal number and their password for use in electronic money transactions (S330), the electronic money management web server 120 transmits the input information to an electronic money management server 100 to request that the electronic money management server 100 confirm whether or not the input mobile communication terminal number and password is identical to a mobile communication terminal number and password stored in the electronic money management server 100 when an electronic money account of the user was opened (S331).

More preferably, a social security number of the owner of the mobile communication terminal is input together with the mobile communication terminal number in order to strengthen the security of the user authentication process.

If the data input by the user is identical to data stored in the electronic money management server 100 (S332), the electronic money management web server 120 notifies the user accordingly (S333). Then, if the user 150 inputs account transfer information, such as the user name, transfer date, and transfer amount, to the electronic money management web server 120 through the user computer 151 (S334), the electronic money management web server 120 confirms the transfer of money from the user using the input account transfer information.

If the transfer of money from the user is confirmed, the electronic money management web server 120 transmits a randomly generated authentication number to the mobile communication terminal number of the user (S335). If the user inputs the received authentication number to the electronic money management web server 120 through the user computer 151 (S336), the electronic money management web server 120 compares the authentication number input by the user with the authentication number transmitted to the mobile communication terminal 153. If the two authentication numbers are identical, the electronic money management web server 120 completes the user authentication and requests that the electronic money management server 100 recharge the electronic money account of the user with an amount of electronic money corresponding to the transferred amount of money (S337).

In addition, the electronic money management web server 120 transmits an SMS message, which indicates that the requested amount of electronic money has been successfully recharged to the electronic money account of the user, to the mobile communication terminal 153 (S338). The SMS message may include a balance of the electronic money account, the recharged amount of electronic money, and the like.

FIG. 3d is a flow diagram illustrating the procedure of a method for recharging electronic money according to a ninth embodiment of the present invention. The electronic money recharging method according to the ninth embodiment of the present invention charges a fee for electronic money recharging by adding it to an information access fee in a bill of a mobile communication company in a similar manner to the electronic money issuance method according to the fourth embodiment.

Specifically, if a user 150 accesses a mobile communication service system 130 through their mobile communication terminal 153 and inputs their mobile communication terminal number and their password for use in electronic money transactions (S340), the mobile communication service system 130 transmits the input information to an electronic money management server 100 to request that the electronic money management server 100 confirm whether or not the input mobile communication terminal number and password is identical to a mobile communication terminal number and password stored in the electronic money management server 100 when an electronic money account of the user was opened (S341).

More preferably, a social security number of the owner of the mobile communication terminal is input together with the mobile communication terminal number in order to strengthen the security of the user authentication process.

If the data input by the user is identical to data stored in the electronic money management server 100 (S342), the mobile communication service system 130 notifies the user accordingly (S343). Then, if the user 150 inputs an amount of electronic money, which the user wishes to recharge, to the mobile communication service system 130 through their mobile communication terminal 153 (S344), the mobile communication service system 130 transmits a randomly generated authentication number to the mobile communication terminal 153 of the user (S345).

If the user inputs the received authentication number to the mobile communication service system 130 through the mobile communication terminal 153 (S346), the mobile communication service system 130 compares the authentication number input by the user with the authentication number transmitted to the mobile communication terminal 153. If the two authentication numbers are identical, the mobile communication service system 130 completes the user authentication and requests that the electronic money management server 100 recharge the electronic money account of the user with the amount of electronic money requested by the user (S347).

In addition, the mobile communication service system 130 transmits an SMS message, which indicates that the requested amount of electronic money has been successfully recharged to the electronic money account of the user, to the mobile communication terminal 153 of the user (S348). The SMS message may include a balance of the electronic money account, the recharged amount of electronic money, and the like.

FIG. 3e is a flow diagram illustrating the procedure of a method for recharging electronic money according to a tenth embodiment of the present invention. The electronic money recharging method according to the tenth embodiment of the present invention charges a fee for electronic money recharging by adding it to an information access fee in a bill of an ARS line provider company in a similar manner to the electronic money issuance method according to the fifth embodiment.

Specifically, if a user 150 accesses an ARS server 110 through their mobile communication terminal 153, input of their mobile communication terminal number can be omitted since the ARS server 110 can detect a Caller Identification (CID) of the mobile communication terminal 153, contrary to the first embodiment of the present invention.

If a password for use in electronic money transactions is input from the mobile communication terminal 153 of the user after the CID has been detected by the ARS server 110 (S350), the ARS server 110 transmits the detected CID and the password to the electronic money management server 100 to request that the electronic money management server 100 confirm whether or not the detected CID and password input by the user is identical to a mobile communication terminal number and password stored in the electronic money management server 100 when an electronic money account of the user was opened (S351).

More preferably, a social security number of the owner of the mobile communication terminal is input together with the mobile communication terminal number in order to strengthen the security of the user authentication process.

If the data input by the user is identical to data stored in the electronic money management server 100 (S352), the ARS server 110 notifies the user accordingly (S353). In this embodiment, the authentication number verification process can be omitted since the user 150 has already been determined to be the holder of the mobile communication terminal 153.

Then, if the user 150 inputs an amount of electronic money, which the user wishes to recharge, to the ARS server 110 through their mobile communication terminal 153 (S354), the ARS server 110 requests that the electronic money management server 100 recharge the electronic money account of the user with the amount of electronic money requested by the user (S355). In addition, the ARS server 110 transmits an SMS message, which indicates that the requested amount of electronic money has been successfully recharged to the electronic money account of the user, to the mobile communication terminal 153 of the user (S356). The SMS message may include a balance of the electronic money account, the recharged amount of electronic money, and the like.

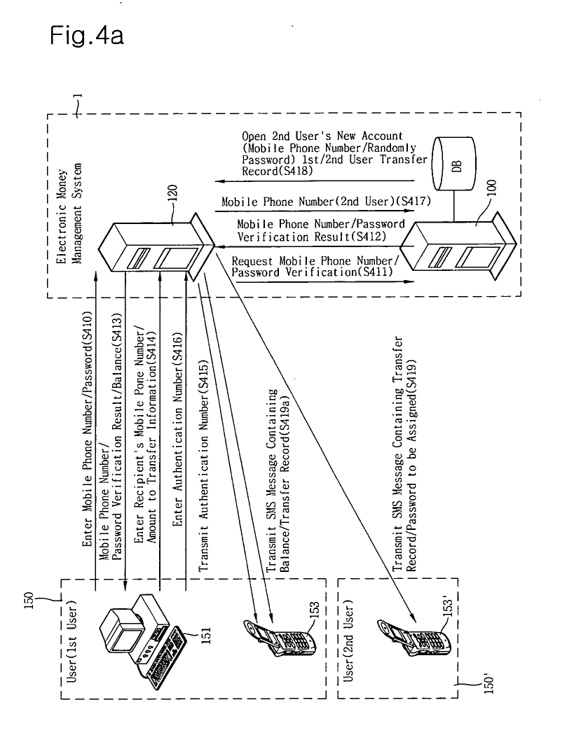

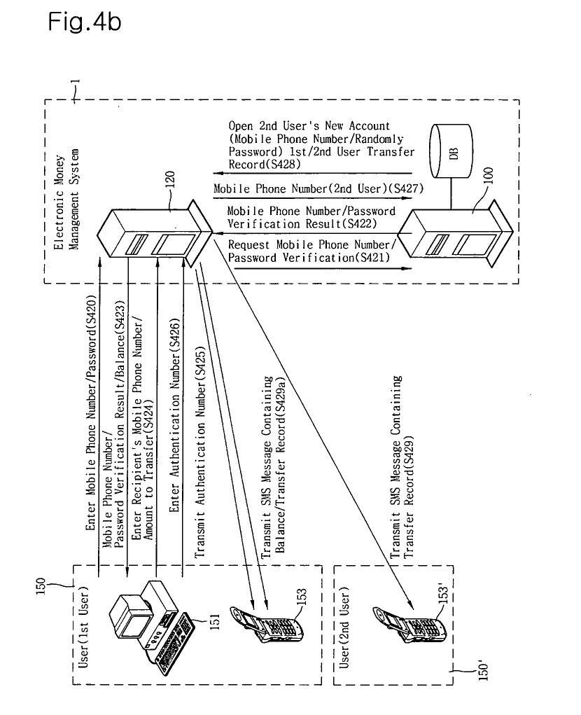

Methods for transferring electronic money issued or recharged in the above manner to a different user according to the present invention will now be described with reference to FIGS. 4a and 4b.

FIG. 4a is a flow diagram illustrating the procedure of a method for transferring electronic money according to an eleventh embodiment of the present invention, which is applied when the recipient of electronic money is a new user.

If a user 150 wishing to transfer electronic money, which is hereinafter referred to as a first user, accesses an electronic money management web server 120 through their computer 151 and inputs their mobile communication terminal number and their password for use in electronic money transactions (S410), the electronic money management web server 120 transmits the input information to an electronic money management server 100 to request that the electronic money management server 100 confirm whether or not the input mobile communication terminal number and password is identical to a mobile communication terminal number and password stored in the electronic money management server 100 when an electronic money account of the user was opened (S411).

More preferably, a social security number of the owner of the mobile communication terminal is input together with the mobile communication terminal number in order to strengthen the security of the user authentication process.

If the data input by the user is identical to data stored in the electronic money management server 100 (S412), the electronic money management web server 120 notifies the first user 150 accordingly and notifies the first user 150 of the balance of an electronic money account identified by the mobile communication terminal number and password (S413). Then, if the first user 150 inputs a mobile communication terminal number of a recipient of electronic money, which is hereinafter referred to as a second user 150′, and an amount of money to be transferred to the second user 150′ to the electronic money management web server 120 through the computer 151 of the first user 150 (S414), the electronic money management web server 120 transmits a randomly generated authentication number to the mobile communication terminal 153 of the first user 150 (S415).

If the first user 150 inputs the received authentication number to the electronic money management web server 120 through the computer 151 of the first user (S416), the electronic money management web server 120 compares the authentication number input by the first user with the authentication number transmitted to the mobile communication terminal 153 to determine whether or not the two authentication numbers are identical. If the two authentication numbers are identical, the electronic money management web server 120 proceeds to an electronic money transfer process.

Specifically, the electronic money management web server 120 transmits the mobile communication terminal number of the second user 150′ and the amount of money to be transferred thereto to the electronic money management server 100 to request that the electronic money management server 100 perform electronic money transfer (S417). If the mobile communication terminal number of the second user 150′ has not been registered, the electronic money management server 100 regards the second user as a new user, and opens an electronic money account identified by the mobile communication terminal number of the second user and stores both a randomly-assigned password for the opened electronic money account and its transfer record.

When the new electronic money account is opened and the electronic money is transferred to the new account in this manner (S418), the electronic money management web server 120 transmits an SMS message containing the randomly-assigned password and the transfer record to the mobile communication terminal 153′ of the second user 150′ (S419). The electronic money management web server 120 also transmits an SMS message containing the electronic money transfer record to the mobile communication terminal 153 of the first user 150 (S419a).

FIG. 4b is a flow diagram illustrating the procedure of a method for transferring electronic money according to a twelfth embodiment of the present invention, which is applied when the recipient of electronic money is an existing user.

A detailed description of this embodiment is herein omitted since the procedure of this embodiment is similar to that of the eleventh embodiment except that electronic money transfer is possible without opening a new electronic money account as the recipient of electronic money is an existing user, which is hereinafter referred to as a second user.

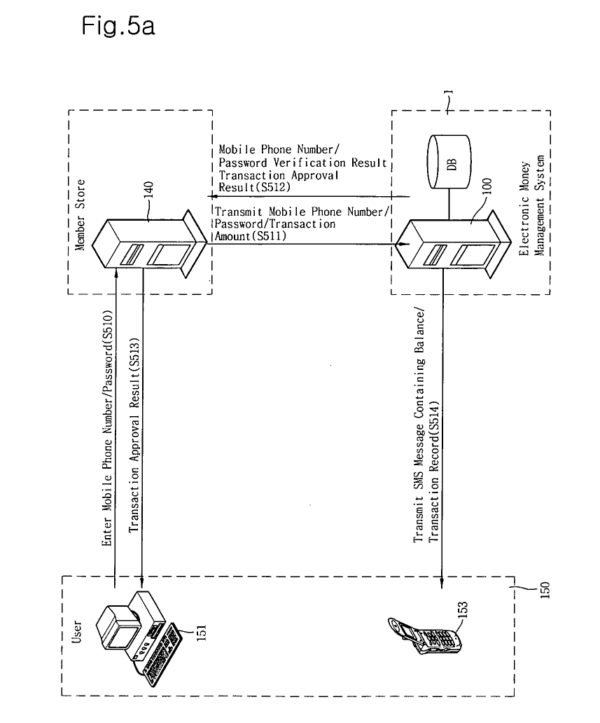

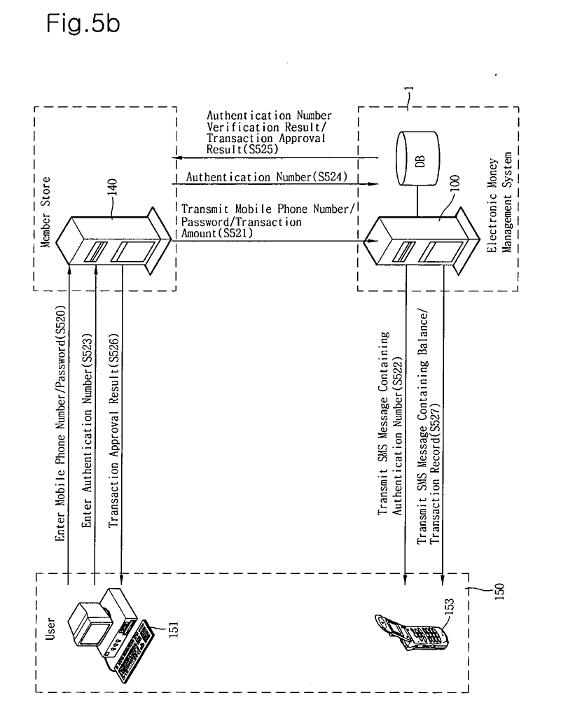

Methods for paying prices for electronic transactions using electronic money issued, recharged, or transferred in the above manner according to the present invention will now be described with reference to FIGS. 5a and 5b.

FIG. 5a is a flow diagram illustrating the procedure of a method for conducting electronic transactions using electronic money according to a thirteenth embodiment of the present invention.

As shown in FIG. 5a, a user 150 accesses a web server of a member store, with which the user 150 desires to conduct an electronic transaction, through a user computer 151, and inputs their mobile communication terminal number and their password for use in electronic money transactions (S510).

More preferably, a social security number of the owner of the mobile communication terminal is input together with the mobile communication terminal number in order to strengthen the security of the user authentication process.

If the mobile communication terminal number (for example, a mobile phone number) of the user 150 and the password are input in such a manner, the member store web server 140 transmits the input data and information of an amount of money for purchasing an article (i.e., a transaction amount of money) to a server 100 of an electronic money management company to request the server 100 to conduct settlement (S511).

The electronic money management server 100 compares the input mobile communication terminal number and password with a mobile communication terminal number and password stored in the electronic money management server 100 when an electronic money account of the user was opened, to verify that the input mobile communication terminal number and password are identical to the stored ones. If the input mobile communication terminal number and password are identical to the stored ones and the balance of an electronic money account identified by the mobile communication terminal number and password is equal to or larger than the transaction amount of money, the electronic money management server 100 transmits a transaction approval to the member store server 140 and stores a record of the transaction (S512).

Upon receiving the transaction approval, the member store web server 140 completes the electronic transaction, and notifies the user computer 151 of the transaction approval (S 513). The electronic money management server 100 transmits the transaction record and information of the balance of the electronic money account to the mobile communication terminal 153 of the user via an SMS message (S514).

FIG. 5b is a flow diagram illustrating the procedure of a method for conducting electronic transactions using electronic money according to a fourteenth embodiment of the present invention.

As shown in FIG. 5b, a user 150 accesses a web server of a member store through a user computer 151 to conduct an electronic transaction, and inputs their mobile communication terminal number and their password for use in electronic money transactions (S520).

More preferably, a social security number of the owner of the mobile communication terminal is input together with the mobile communication terminal number in order to strengthen the security of the user authentication process.

If the mobile communication terminal number (for example, a mobile phone number) of the user 150 and the password are input in such a manner, the member store web server 140 transmits the input data and information of an amount of money for purchasing an article (i.e., a transaction amount of money) to a server 100 of an electronic money management company to request the server 100 to conduct settlement (S521).

The electronic money management server 100 compares the input mobile communication terminal number and password with a mobile communication terminal number and password stored in the electronic money management server 100 when an electronic money account of the user was opened, to verify that the input mobile communication terminal number and password are identical to the stored ones. Then, the electronic money management server 100 transmits a randomly generated authentication number to the mobile communication terminal 153 of the user to achieve secure transaction (S522).

If the user inputs the received authentication number to the member store web server 140 through the user computer 151 (S523), the member store web server 140 transmits the input authentication number to the electronic money management server 100 (S524). The member store web server 140 compares the authentication number input by the user with the authentication number transmitted to the mobile communication terminal 153. If the two authentication numbers are identical and the balance of an electronic money account identified by the mobile communication terminal number and password is equal to or larger than the transaction amount of money, the electronic money management server 100 transmits a transaction approval to the member store web server 140 and stores a record of the transaction (S525).

Upon receiving the transaction approval, the member store web server 140 completes the electronic transaction, and notifies the user computer 151 of the transaction approval (S 526). The electronic money management server 100 transmits the transaction record and information of the balance of the electronic money account to the mobile communication terminal 153 of the user (S527).

The fourteenth embodiment of the present invention is characterized by employing an authentication process using an authentication number to strengthen the security of electronic transactions.

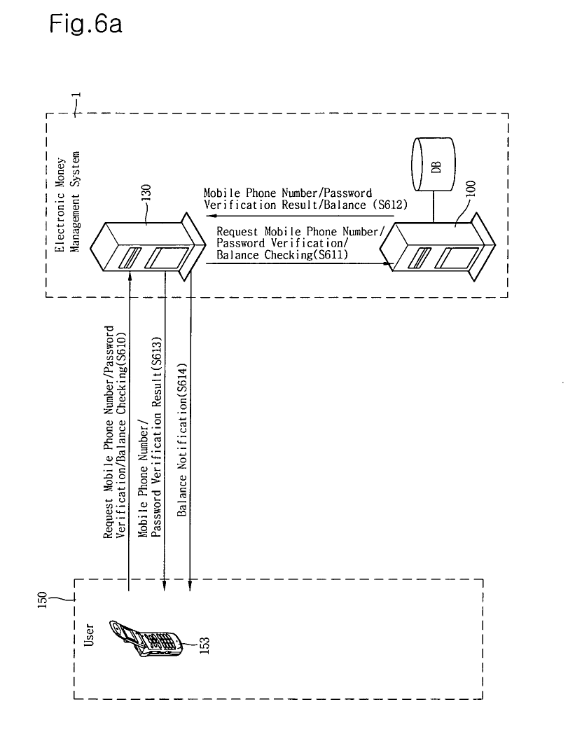

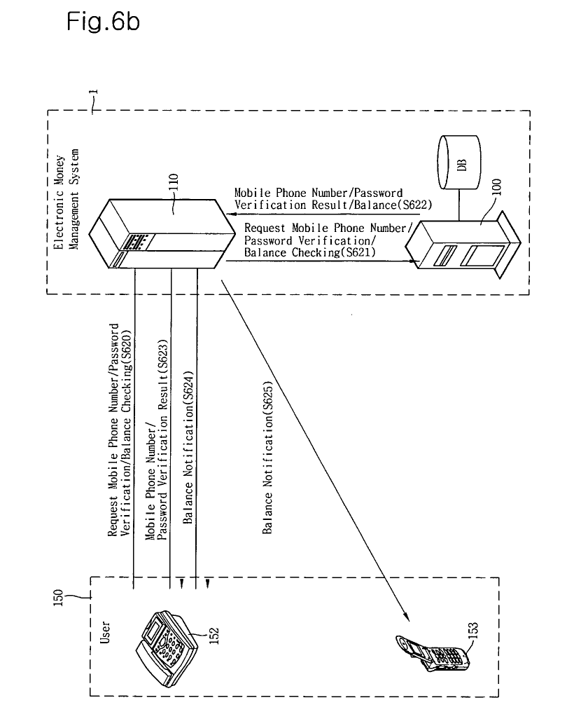

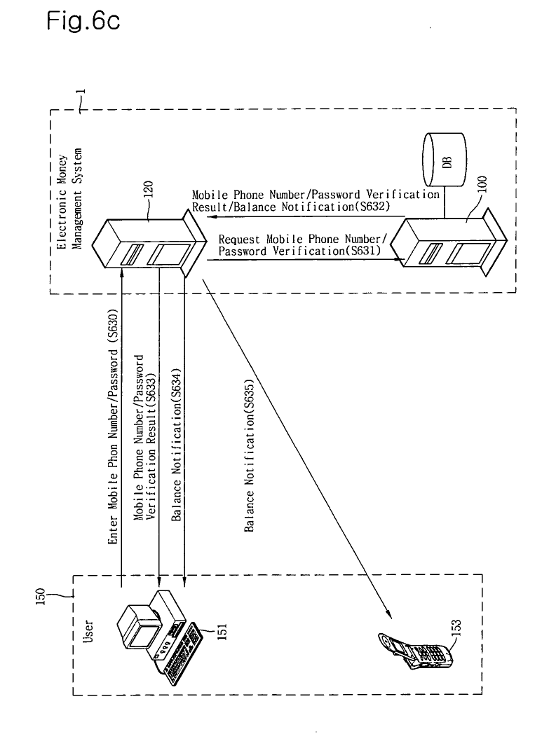

Methods for checking the balance of an electronic money account according to the present invention will now be described with reference to FIGS. 6a to 6c.

FIG. 6a is a flow diagram illustrating the procedure of a method for checking the balance of an electronic money account according to a fifteenth embodiment of the present invention, which employs a mobile communication service system 130 to check the balance of the electronic money account.

A user 150 accesses a mobile communication service system 130 through a mobile communication terminal 153 and inputs their mobile communication terminal number and their password for use in electronic money transactions so that the user can request that the mobile communication service system 130 check the balance of an electronic money account of the user (S610).

More preferably, a social security number of the owner of the mobile communication terminal is input together with the mobile communication terminal number in order to strengthen the security of the user authentication process.

Upon receiving the balance checking request, the mobile communication service system 130 transmits the input mobile communication terminal number and password to an electronic money management server 100 (S611). The electronic money management server 100 compares the input mobile communication terminal number and password with a mobile communication terminal number and password stored in the electronic money management server 100 when an electronic money account of the user was opened, to verify that the input mobile communication terminal number and password are identical to the stored ones. If the input mobile communication terminal number and password are identical to the stored ones, the electronic money management server 100 notifies the mobile communication service system 130 of the verification result and the balance of the electronic money account (S612).

Accordingly, the mobile communication service system 130 notifies the mobile communication terminal 153 of the user of the balance of the electronic money account together with the verification result of the mobile communication terminal number and password via an SMS message (S613 and S614).

FIG. 6b is a flow diagram illustrating the procedure of a method for checking the balance of an electronic money account according to a sixteenth embodiment of the present invention, which employs an ARS server 110 to check the balance of the electronic money account.

A user 150 accesses an ARS server 110 through a telephone 152 and inputs their mobile communication terminal number and their password for use in electronic money transactions so that the user can request the ARS server 110 to check the balance of an electronic money account of the user (S620).

More preferably, a social security number of the owner of the mobile communication terminal is input together with the mobile communication terminal number in order to strengthen the security of the user authentication process.

Upon receiving the balance checking request, the ARS server 110 transmits the input mobile communication terminal number and password to an electronic money management server 100 (S621). The electronic money management server 100 compares the input mobile communication terminal number and password with a mobile communication terminal number and password stored in the electronic money management server 100 when an electronic money account of the user was opened, to verify that the input mobile communication terminal number and password are identical to the stored ones. If the input mobile communication terminal number and password are identical to the stored ones, the electronic money management server 100 notifies the ARS server 110 of the verification result and the balance of the electronic money account (S622).

Accordingly, the ARS server 110 notifies the telephone 152 of the user of the balance of the electronic money account together with the verification result of the mobile communication terminal number and password (S623 and S624). In a preferred embodiment of the present invention, the ARS server 110 may also notify the mobile communication terminal 153 of the user of the balance of the electronic money account (S625).

FIG. 6c is a flow diagram illustrating the procedure of a method for checking the balance of an electronic money account according to a seventeenth embodiment of the present invention, in which the user checks the balance of an electronic money account of the user through a user computer 151 on the homepage of an electronic money management company.

A user 150 accesses an electronic money management web server 120 through the user computer 151 and inputs their mobile communication terminal number and their password for use in electronic money transactions so that the user can request that the electronic money management web server 120 check the balance of an electronic money account of the user (S630).

More preferably, a social security number of the owner of the mobile communication terminal is input together with the mobile communication terminal number in order to strengthen the security of the user authentication process.

The electronic money management web server 120 transmits the input mobile communication terminal number and password to an electronic money management server 100 (S631). The electronic money management server 100 compares the input mobile communication terminal number and password with a mobile communication terminal number and password stored in the electronic money management server 100 when an electronic money account of the user was opened, to verify that the input mobile communication terminal number and password are identical to the stored ones. If the input mobile communication terminal number and password are identical to the stored ones, the electronic money management server 100 notifies the electronic money management web server 120 of the verification result and the balance of the electronic money account (S632).

Accordingly, the electronic money management web server 120 notifies the user computer 151 of the balance of the electronic money account together with the verification result of the mobile communication terminal number and password (S633 and S634). The electronic money management web server 120 may also notify the mobile communication terminal 153 of the user of the balance of the electronic money account (S635).

As is apparent from the above description, the present invention provides an electronic money management method and system, in which a user is identified by checking the possession of their mobile communication terminal, thereby strengthening the security, and electronic money transactions such as issuance, transfer, and balance checking of electronic money can also be conducted through an ARS or the Internet, thereby making it possible to securly and conveniently pay prices even for low-cost electronic transactions regardless of time or place.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for managing electronic money for use in electronic transactions, the method comprising:
an Automatic Response System (ARS) server receiving electronic money issuance data from a user telephone, the electronic money issuance data including a mobile communication terminal number of a user, a password for use in electronic money transactions, and an amount of electronic money which the user desires to be issued;
the ARS server transmitting an authentication number to a mobile communication terminal of the user;
the ARS server receiving an authentication number input by the user from the user telephone;
the ARS server comparing the authentication number input by the user with the authentication number transmitted to the mobile communication terminal of the user and transmitting the electronic money issuance data to an electronic money management server to request that the electronic money management server issue the amount of electronic money if the authentication numbers are identical;
the electronic money management server issuing the requested amount of electronic money to an electronic money account of the user identified by the password and the mobile communication terminal number of the user; and
the ARS server notifying the mobile communication terminal of the user of completion of the electronic money issuance if the electronic money has been issued.

2. The electronic money management method according to claim 1, wherein, upon receiving the request to issue electronic money, the electronic money management server searches for the electronic money account of the user identified by the password and the mobile communication terminal number of the user, opens a new electronic money account identified by the password and the mobile communication terminal number of the user if the electronic money account of the user is not present, and recharges the electronic money account of the user with the requested amount of electronic money if the electronic money account of the user is present.

3. The electronic money management method according to claim 1, wherein, if the electronic money issuance is completed, the ARS server transmits a Short Message Service (SMS) message to the mobile communication terminal, the SMS message containing at least one of a balance of the electronic money account, an issued amount of money, and a recharged amount of money, or containing a combination thereof.

4. A method for managing electronic money for use in electronic transactions, the method comprising:
an electronic money management web server receiving electronic money issuance data from a user computer, the electronic money issuance data including a mobile communication terminal number of a user, a password for use in electronic money transactions, and an amount of electronic money which the user desires to be issued;
the electronic money management web server transmitting an authentication number to a mobile communication terminal of the user;
the electronic money management web server receiving an authentication number input by the user from the user computer;
the electronic money management web server comparing the authentication number input by the user with the authentication number transmitted to the mobile communication terminal of the user and receiving information of means for paying the amount of electronic money from the user computer if the authentication numbers are identical;
the electronic money management web server transmitting the electronic money issuance data to an electronic money management server to request that the electronic money management server issue the amount of electronic money if the payment is completed;
the electronic money management server issuing the requested amount of electronic money to an electronic money account identified by the password and the mobile communication terminal number of the user; and
the electronic money management web server notifying the mobile communication terminal of the user of completion of the electronic money issuance if the electronic money has been issued.

5. The electronic money management method according to claim 4, wherein, upon receiving the request to issue electronic money, the electronic money management server searches for the electronic money account of the user identified by the password and the mobile communication terminal number of the user, opens a new electronic money account identified by the password and the mobile communication terminal number of the user if the electronic money account of the user is not present, and recharges the electronic money account of the user with the requested amount of electronic money if the electronic money account of the user is present.

6. The electronic money management method according to claim 4, wherein, if the electronic money issuance is completed, the electronic money management web server transmits a Short Message Service (SMS) message to the mobile communication terminal, the SMS message containing at least one of a balance of the electronic money account, an issued amount of money, and a recharged amount of money, or containing a combination thereof.

7. A method for managing electronic money for use in electronic transactions, the method comprising:
an electronic money management web server determining whether or not an amount of money for issuing electronic money has been transferred from a user if the electronic money management web server receives information of the transferred amount of money, transfer date, and a user name from a user computer;
if it is determined that the amount of money for issuing the electronic money has been transferred, the electronic money management web server receiving electronic money issuance data from the user computer, the electronic money issuance data including a mobile communication terminal number of the user, a password for use in electronic money transactions, and an amount of electronic money which the user desires to be issued;
the electronic money management web server transmitting an authentication number to a mobile communication terminal of the user;
the electronic money management web server receiving an authentication number input by the user from the user computer;
the electronic money management web server comparing the authentication number input by the user with the authentication number transmitted to the mobile communication terminal of the user and transmitting the electronic money issuance data to an electronic money management server to request that the electronic money management server issue the amount of electronic money if the authentication numbers are identical;
the electronic money management server issuing the requested amount of electronic money to an electronic money account identified by the password and the mobile communication terminal number of the user; and
the electronic money management web server notifying the mobile communication terminal of the user of completion of the electronic money issuance if the electronic money has been issued.

8. The electronic money management method according to claim 7, wherein, upon receiving the request to issue electronic money, the electronic money management server searches for the electronic money account of the user identified by the password and the mobile communication terminal number of the user, opens a new electronic money account identified by the password and the mobile communication terminal number of the user if the electronic money account of the user is not present, and recharges the electronic money account of the user with the requested amount of electronic money if the electronic money account of the user is present.

9. The electronic money management method according to claim 7, wherein, if the electronic money issuance is completed, the electronic money management web server transmits a Short Message Service (SMS) message to the mobile communication terminal, the SMS message containing at least one of a balance of the electronic money account, an issued amount of money, and a recharged amount of money, or containing a combination thereof.

10. A method for managing electronic money for use in electronic transactions, the method comprising:
a mobile communication service system receiving electronic money issuance data from a mobile communication terminal of a user, the electronic money issuance data including a mobile communication terminal number of the user, a password for use in electronic money transactions, and an amount of electronic money which the user desires to be issued;
the mobile communication service system transmitting an authentication number to the mobile communication terminal of the user;
the mobile communication service system receiving an authentication number input by the user from the mobile communication terminal of the user;
the mobile communication service system comparing the authentication number input by the user with the authentication number transmitted to the mobile communication terminal of the user and transmitting the electronic money issuance data to an electronic money management server to request that the electronic money management server issue the amount of electronic money if the authentication numbers are identical;
the electronic money management server issuing the requested amount of electronic money to an electronic money account of the user identified by the password and the mobile communication terminal number of the user; and
the mobile communication service system notifying the mobile communication terminal of the user of completion of the electronic money issuance if the electronic money has been issued.

11. The electronic money management method according to claim 10, wherein the mobile communication service system detects the mobile communication terminal number of the user through a Caller Identification (CID) of the mobile communication terminal.

12. The electronic money management method according to claim 10, wherein, upon receiving the request to issue electronic money, the electronic money management server searches for the electronic money account of the user identified by the password and the mobile communication terminal number of the user, opens a new electronic money account identified by the password and the mobile communication terminal number of the user if the electronic money account of the user is not present, and recharges the electronic money account of the user with the requested amount of electronic money if the electronic money account of the user is present.

13. The electronic money management method according to claim 10, wherein, if the electronic money issuance is completed, the mobile communication service system transmits a Short Message Service (SMS) message to the mobile communication terminal, the SMS message containing at least one of a balance of the electronic money account, an issued amount of money, and a recharged amount of money, or containing a combination thereof.

14. A method for managing electronic money for use in electronic transactions, the method comprising:
an electronic money management web server transmitting a mobile communication terminal number of a first user who makes a transfer request and a password for use in electronic money transactions, which are received together with the transfer request from a user computer, to an electronic money management server to request that the electronic money management server check a balance of an electronic money account of the first user;
the electronic money management web server transmitting a result of the balance checking to the user computer and receiving electronic money transfer data from the user computer, the electronic money transfer data including a mobile communication terminal number of a second user who is to receive electronic money and an amount of money to be transferred;
the electronic money management web server transmitting an authentication number to a mobile communication terminal of the first user;
the electronic money management web server receiving an authentication number input by the first user from the user computer;
the electronic money management web server comparing the authentication number input by the user with the authentication number transmitted to the mobile communication terminal of the first user and transmitting the electronic money transfer data to an electronic money management server to request that the electronic money management server transfer the amount of electronic money if the authentication numbers are identical;
the electronic money management server transferring the requested amount of electronic money to an electronic money account identified by the mobile communication terminal number of the second user; and
the electronic money management web server notifying the mobile communication terminals of the first and second users of completion of the electronic money transfer if the electronic money has been transferred.

15. The electronic money management method according to claim 14, wherein, upon receiving the request to transfer electronic money, the electronic money management server searches for an electronic money account identified by the mobile communication terminal number of the second user, and if the electronic money account of the second user is not present, the electronic money management server opens a new electronic money account identified by the mobile communication terminal number of the second user and transfers the requested amount of electronic money to the new electronic money account of the second user after randomly assigning a password thereto, and if an electronic money account of the second user is present, the electronic money management server recharges the electronic money account of the second user with the requested amount of electronic money.

16. The electronic money management method according to claim 14, wherein, if the electronic money transfer is completed, the electronic money management web server transmits an SMS message containing a transfer record and a balance of the electronic money account of the first user to the mobile communication terminal of the first user and transmits an SMS message containing the transfer record, a balance of the electronic money account of the second user, and an randomly-assigned password to the mobile communication terminal of the second user.

17. A method for managing electronic money for use in electronic transactions, the method comprising:
a member store web server receiving a mobile communication terminal number of a user who has decided to conduct a transaction and a password for use in electronic money transactions from a user computer of the user and transmitting the received mobile communication terminal number and password, together with an amount of money for the transaction, to an electronic money management server;
the electronic money management server receiving an authentication number input by the user from the user computer;
the electronic money management server comparing the authentication number input by the user with the authentication number transmitted to the mobile communication terminal of the user and, if the authentication numbers are identical, determining whether or not a balance of an electronic money account of the user identified by the password and the mobile communication terminal number of the user is equal to or larger than the amount of money for the transaction; and
the electronic money management server notifying the member store web server of approval of the transaction and storing a record of the transaction if the balance of the electronic money account of the user is equal to or larger than the amount of money for the transaction.

18. The electronic money management method according to claim 17, further comprising:
the electronic money management server transmitting an SMS message containing the transaction record and the balance of the electronic money account of the user to the mobile communication terminal of the user after the transaction approval notification.

19. A method for managing electronic money for use in electronic transactions, the method comprising:
one of a mobile communication service system, an ARS server, and an electronic money management web server receiving and transmitting a balance checking request, together with a mobile communication terminal number of a user and a password for use in electronic money transactions, to an electronic money management server;
the electronic money management server checking a balance of an electronic money account of the user identified by the password and the mobile communication terminal number of the user and transmitting a result of the balance checking to the one of the mobile communication service system, the ARS server, and the electronic money management web server which has received the balance checking request; and
the one of the mobile communication service system, the ARS server, and the electronic money management web server receiving and transmitting the balance checking result to the mobile communication terminal of the user via an SMS message.

20. An electronic money management system comprising:
one of an ARS server, an electronic money management web server, and a mobile communication service system which transmits an authentication number to a mobile communication terminal of a user upon receiving an electric money issuance, recharging, transfer, or balance checking request, together with a mobile communication terminal number of the user and a password for use in electronic money transactions, from the user, compares the authentication number transmitted to the mobile communication terminal of the user with an authentication number received from the user, and transmits the password and the mobile communication terminal number of the user to make the electric money issuance, recharging, transfer, or balance checking request if the two authentication numbers are identical; and
an electronic money management server for issuing electronic money to, recharging electronic money to, or transferring electronic money from an electronic money account identified by the password and the mobile communication terminal number of the user upon receiving the electric money issuance, recharging, transfer, or balance checking request from the one of the ARS server, the electronic money management web server, and the mobile communication service system, and for transmitting a result of the electronic money issuance, recharging, or transfer and a balance of the electronic money account of the user to the mobile communication terminal of the user through the one of the ARS server, the electronic money management web server, and the mobile communication service system.
